(19) United States
(12) Patent Application Publication
(10) Pub. No.: US 2009/0188990 A1
(43) Pub. Date: Jul. 30, 2009

(54) FUEL INJECTOR AND INTERNAL COMBUSTION ENGINE

(75) Inventors: Motoyuki ABE, Hitachinaka (JP); Akiko Komeda, Musashino (JP); Tohru Ishikawa, Kitaibaraki (JP); Takehiko Kowatari, Kashiwa (JP); Noriyuki Maekawa, Kashiwa (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Ltd., Tokyo (JP)

(21) Appl. No.: 12/360,515

(22) Filed: Jan. 27, 2009

(30) Foreign Application Priority Data
Jan. 28, 2008 (JP) 2008-015753

(51) Int. Cl. B05B 1/08

(52) U.S. Cl. 239/101

(57) ABSTRACT

The present invention provides a simplified fuel injector which uses fuel as hydraulic oil to intensify the injection pressure.

A pressure intensifier of the fuel injector is provided with a pressurization piston 106, a first fuel chamber 107 that communicates with a fuel inlet passage 101 (or a fuel supply passage), and a fuel pressurization chamber 111. The pressurization chamber 111 is provided inside a valve body 110. The pressurization piston 106 is formed displaceably relative to the valve body 110 and is provided with a first pressure receiving surface 106a and a pressurization piston portion 106b. The first pressure receiving surface 106a is one end surface of the pressurization piston 106 which faces one of the piston displacement directions 106d, that is, faces the first fuel chamber 107. The pressurization piston portion 106b is provided on the other end surface of the piston 106 which faces the other direction of the piston displacement directions 106d, that is, faces the pressurization chamber 111. The area of the pressurization piston portion 106b which faces the pressurization chamber 111 is smaller than that of the first pressure receiving surface 106a, and the pressurization piston portion 106b serves to change the volume of the pressurization chamber 111.

### BACKGROUND OF THE INVENTION

1. Field of the Invention

The present invention relates to a fuel injector used for an internal combustion engine to pressurize fuel to pressure higher than that at fuel supply and then inject the fuel. The present invention also relates to an internal combustion engine using the fuel injector.

2. Description of the Related Art

JP-A-2002-202021 discloses a fuel injection system having a pressure intensifier which increases the fuel pressure using the supplied fuel as hydraulic oil wherein a valve is opened by the pressurized fuel at the time of fuel injection.

### SUMMARY OF THE INVENTION

With a conventional fuel injector using a pressure intensifier, a fluid passage for connecting a pressure intensifier and a valve body is required, and a structure is disclosed in which the fluid passage is connected to a fuel supply passage through a check valve. The pressure intensifier, therefore, required the fluid passage which connects during pressurization operation a pressurization chamber of the pressure intensifier and a fuel filled volume around the valve body which is opened by pressure rise.

Therefore, it is necessary for the pressure intensifier to compress not only the fuel to be injected but also the fuel in the fluid passage connecting the pressurization chamber and the fuel filled volume around the valve body. There has been a problem of an increase in volume of the fuel to be pressurized by the pressure intensifier. The increase in volume of the fuel to be pressurized by the pressure intensifier causes reduction in efficiency of the pressure intensifier. Therefore, in order to compress and pressurize the fuel with less energy, it is necessary to minimize the volume of the fuel to be compressed to increase the efficiency.

The fuel passage connected from the pressure intensifier to the fuel filled volume around the valve body has a problem that the actual structure inherently becomes complicated. Therefore, there has been a problem that a fuel injection system having a pressure intensifier will increase in size or internal-structural complexity resulting in a cost increase.

Further, in order to establish a fuel injection system, it is necessary to supply fuel to the pressure intensifier and the fuel filled volume around the valve body. A conventional fuel injection system using a pressure intensifier performs fuel supply operation through a check valve which opens only when pressurization operation completes and then the pressure of the fuel filled volume decreases. However, there has been a problem that a fuel injection system including such a check valve becomes complicated and the system itself increases in size and cost.

The present invention has been devised in view of the above problems. An object of the present invention is to attain a simplified fuel injection system having a pressure intensifier operating at high efficiency by decreasing the size of the fuel passage connecting the pressure intensifier and the fuel filled volume around the valve body.

In order to attain the above-mentioned object, the present invention is provided with a pressurization chamber of a pressurization mechanism in the valve body which performs fuel sealing and fuel injection when the valve body is in contact with and separated from a valve seat, respectively. In this way, providing a pressure intensifier in the valve body and providing a fluid passage communicating with the fuel filled volume around the valve body make it possible to configure a fuel injection system having a pressure intensifier without having a complicated fuel passage.

Further, the fuel injection system is configured such that the valve body and a stopper for regulating the valve lift of the valve body can intercept the fuel passage for supplying the fuel to the pressurization chamber. The above configuration makes it possible, when valve body is opened, to intercept the fuel supply passage thus preventing the pressurized fuel from leaking to the low-pressure fuel supply side. On the other hand, when the valve body is closed, the fuel passage is not intercepted by the stopper allowing the fuel to be supplied from the fuel supply side to the fuel filled volume around the valve body as well as to the pressurization chamber. That is, the stopper for regulating the valve lift of the valve body can bring about the same effect as the check valve.

The above simplified configuration makes it possible to obtain the same effect as in the case of a built-in check valve when the fuel is supplied.

In accordance with the present invention, a fuel injector having a pressurization mechanism can take a relatively simpler form and be made highly efficient.

### BRIEF DESCRIPTION OF THE DRAWINGS

FIG. 1 is a sectional view showing an embodiment of a fuel injection system according to the present invention.

FIG. 2 is a sectional view explaining the operation of the fuel injection system according to the present invention.

FIGS. 3A and 3B are enlarged sectional views of the vicinity of the valve body, for assistance in explaining the valve opening operation of the fuel injection system according to the present invention.

FIGS. 4A and 4B are enlarged sectional views of the vicinity of a stopper, for assistance in explaining the valve opening operation of the fuel injection system according to the present invention.

FIGS. 5A and 5B are enlarged sectional views of the vicinity of the valve body and FIG. 5C is a cross sectional view of the vicinity of the valve body, for assistance in explaining the valve closing operation of the fuel injection system according to the present invention.

FIG. 6 is an enlarged sectional view of the vicinity of the valve body showing a fuel injection system according to a second embodiment of the present invention.

FIG. 7 is a sectional view of an internal combustion engine mounting the fuel injection system according to the present invention.

FIG. 8 is a sectional view of the internal combustion engine mounting the fuel injection system according to the present invention.

FIG. 9 is a sectional view of the internal combustion engine mounting the fuel injection system according to the present invention.

### DESCRIPTION OF THE PREFERRED EMBODIMENTS

The fuel injector according to the present invention is configured as follows:

A fuel injector comprising:

a fuel injection nozzle through which to inject fuel;

a valve body and a valve seat designed to close a fuel passage therebetween when in contact with each other and to open the fuel passage when separated from each other; and

a pressurization mechanism for pressurizing the fuel so that during fuel injection, the fuel is forced through the fuel passage between the valve body and the valve seat by a higher pressure than a pressure to be supplied to a fuel supply passage,

wherein the pressurization means includes a piston-like member, a first fuel chamber that communicates with the fuel supply passage, and a pressurization chamber for pressuring the fuel therein;

wherein the pressurization chamber is provided inside the valve body such that the pressurization chamber communicates with the fuel injection nozzle via the fuel passage between the valve body and the valve seat; and

wherein the piston-like member is provided in such a way as to be displaceable relative to the valve body and is provided with a first pressure-receiving surface and a pressurization piston portion, the first pressure receiving surface being one end surface of the piston-like member which faces one of the piston displacement directions, that is, faces the first fuel chamber, to receive the fuel pressure acting in the other direction of the piston displacement directions, the pressurization piston portion being provided on the other end surface of the piston-like member which faces the other direction of the piston displacement directions, that is, faces the pressurization chamber, to change the volume of the pressurization chamber, the area of the pressurization piston portion which faces the pressurization chamber being smaller than that of the first pressure-receiving surface.

The fuel injector according to the present invention is preferably such that the pressurization mechanism is provided with a control valve connected to a pipe having a pressure lower than in the fuel supply passage and with a second fuel chamber communicating with the control valve;

wherein the piston-like member is provided with a second pressure-receiving surface which faces the second fuel chamber to receive the pressure acting in the other direction of the piston displacement directions; and

wherein the piston-like member is driven by a differential pressure between the first and second pressure-receiving surfaces, and the fuel is pressurized by the pressurization piston member changing the volume of the pressurization chamber.

Preferably, the piston-like member is driven in the direction to decrease the volume of the pressurization chamber when the control valve makes the second fuel chamber communicate with the pipe having a pressure lower than in the fuel supply passage.

Preferably, the fuel injector includes a fuel passage for introducing the fuel into the pressurization chamber at the outer section of the valve body and a stopper member for limiting the lift amount of the valve body so as to prevent the flow of the fuel in the fuel passage between the stopper member and the valve body when the valve body is lifted from the valve seat.

Preferably, the injection quantity of the fuel is controlled by the amount of time during which the control valve is open.

Preferably, the fuel injector is disposed in an internal combustion engine such that the fuel injection nozzle faces the inside of a cylinder of the internal combustion engine, and the pressure with which the fuel is supplied to the fuel injector is set to 1 MPa or less. Further, another fuel injector can be provided in the suction port of the internal combustion engine.

### First Embodiment

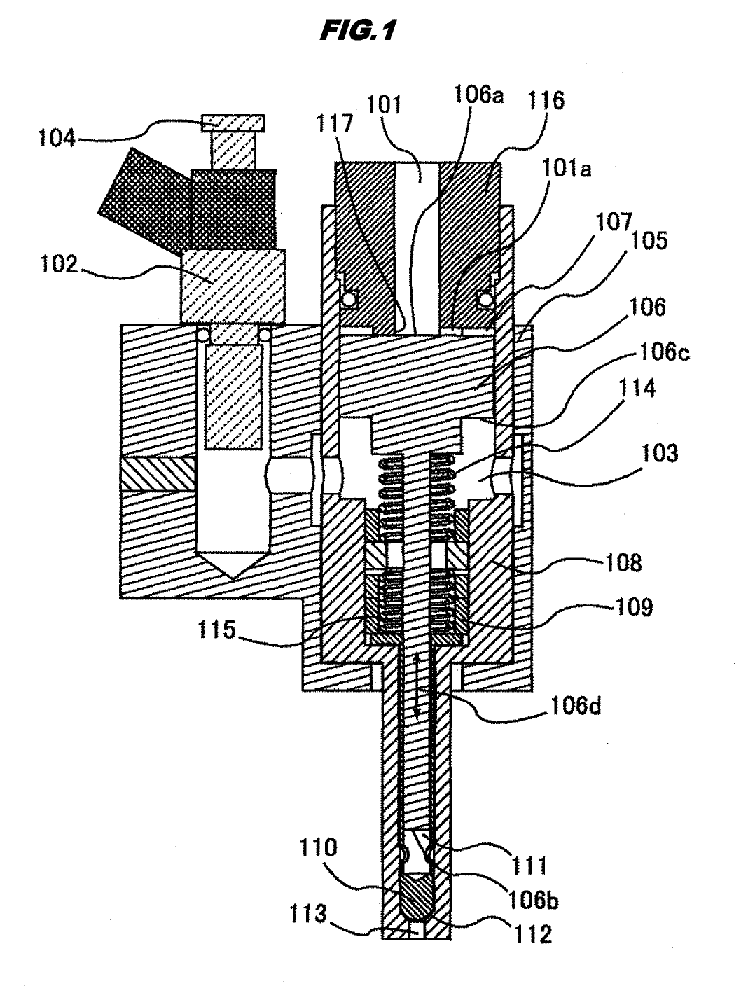

FIG. 1 is a sectional view of a fuel injector according to a first embodiment of the present invention. A fuel inlet passage 101 is connected to a fuel pipe communicating with a fuel pump to receive the fuel pressure. A control valve 102 is a normally-closed, electrically-operable solenoid valve which connects thereto a pipe connecting a fuel outlet passage 104 and a fuel tank. When energized, the control valve 102 is opened to allow communication between a back pressure chamber (second fuel chamber) 103 and the pipe communicating with the fuel tank.

A passage member 116 having a fuel inlet is fixed to a body 108 through screwing, press-fitting, or the like. When the control valve 102 is closed, a pressurization piston (piston-like member) 106 is biased by a spring 114 so as to be in contact with the passage member 116. In this state, in order to apply the fuel pressure to the entire pressure-receiving surface (first pressure-receiving surface) 106a of the pressurization piston 106, it is desirable that the fuel inlet passage 101 communicate with a pressure supply chamber (first fuel chamber) 107 which is a space on the fuel supply side even when the passage member 116 is in contact with the pressurization piston 106. Specifically, it is preferable to form a projection 117 on the piston-106-facing bottom surface of the passage member 116, through which the fuel inlet passage 101 is formed, and to provide a fuel passage 101a through the projection 117 in the form of a slot or side hole.

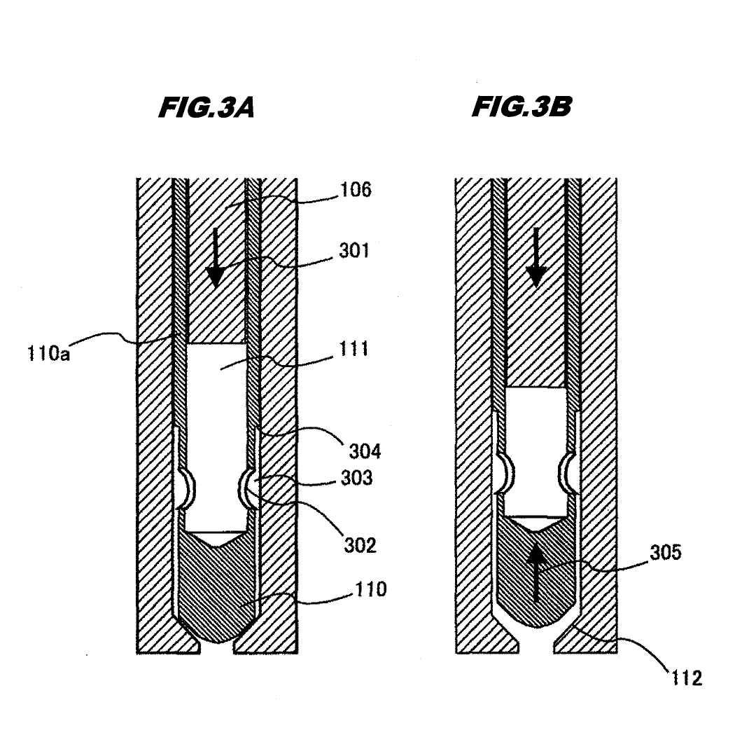

A pressure intensifier (pressurization mechanism) for the fuel injector is composed of the pressure supply chamber 107, the pressurization piston 106, the back pressure chamber 103, and a pressurization chamber 111. A valve body 110 opens and closes a fuel passage between the valve body 110 and a valve seat 112 to control fuel injection from a fuel injection nozzle 113. As shown in FIG. 3, the valve body 110 is provided with a hollow cylinder-shaped rod portion 110a forming a cylinder-like concave portion, and the pressurization chamber 111 is formed by the pressurization piston 106 being inserted into the concave portion.

A pressure-receiving surface (second pressure-receiving surface) 106c is formed on the side of the pressurization piston 106 which is opposite the pressure-receiving surface 106a so as to face the back pressure chamber 103. Further, provided at the distal end of the pressurization piston 106 which is located opposite the pressure receiving surface 106a is a pressurization piston portion 106b, the bottom surface of which faces the pressurization chamber 111.

The valve body 110 is provided slidably inside the body 108, and the upstream side of the valve body 110 faces the back pressure chamber 103 and is biased by a spring 115. The amount of vertical displacement of the valve body 110 is defined by a stopper 109. The valve body 110 is in its open state when its surface facing the back pressure chamber 103 is in contact with the stopper 109 and in its closed state when it is in contact with the valve seat 112.

The above configuration of the fuel injector can be summarized as below.

The pressure intensifier is provided with the pressurization piston 106, the first fuel chamber 107 that communicates with the fuel inlet passage 101 (or the fuel supply passage), and the fuel pressurization chamber 111.

The pressurization chamber 111 is provided inside the valve body 110 such that the chamber 111 communicates with the fuel injection nozzle 113 through the fuel passage between the valve seat 112 and the valve body 110.

The pressurization piston 106 is formed displaceably relative to the valve body 110 and is provided with the first pressure receiving surface 106a and the pressurization piston portion 106b. The first pressure receiving surface 106a is one end surface of the piston 106 which faces one of the piston displacement directions 106d, that is, faces the first fuel chamber 107, to receive the fuel pressure acting in the other direction of the piston displacement directions 106d. The pressurization piston portion 106b is provided on the other end surface of the piston 106 which faces the other direction of the piston displacement directions 106d, that is, faces the pressurization chamber 111. The area of the pressurization piston portion 106b which faces the pressurization chamber 111 is smaller than that of the first pressure receiving surface 106a, and the pressurization piston portion 106b serves to change the volume of the pressurization chamber 111.

The pressure intensifier is further provided with the control valve 102 connected to a pipe (the fuel outlet passage 104) having a lower pressure than in the fuel inlet passage 101, or a fuel supply passage, and with the second fuel chamber 103 communicating with the control valve 102. The pressurization piston 106 is provided with the second pressure-receiving surface 106c which faces the second fuel chamber 103 to receive the fuel pressure acting in one of the piston displacement directions 106d. The pressurization piston 106 is driven by the differential pressure between the first pressure-receiving surface 106a and the second pressure-receiving surface 106c, and the fuel is pressurized by the pressurization piston member 106b changing the volume of the pressurization chamber 111.

With the above configuration, the pressurization piston 106 is integrally composed of the driving piston member having the first pressure-receiving surface 106a and the second pressure-receiving surface 106c to generate a force for driving the pressurization piston 106 and the pressurization piston member 106b which changes the volume of the pressurization chamber 111 to pressurize the fuel.

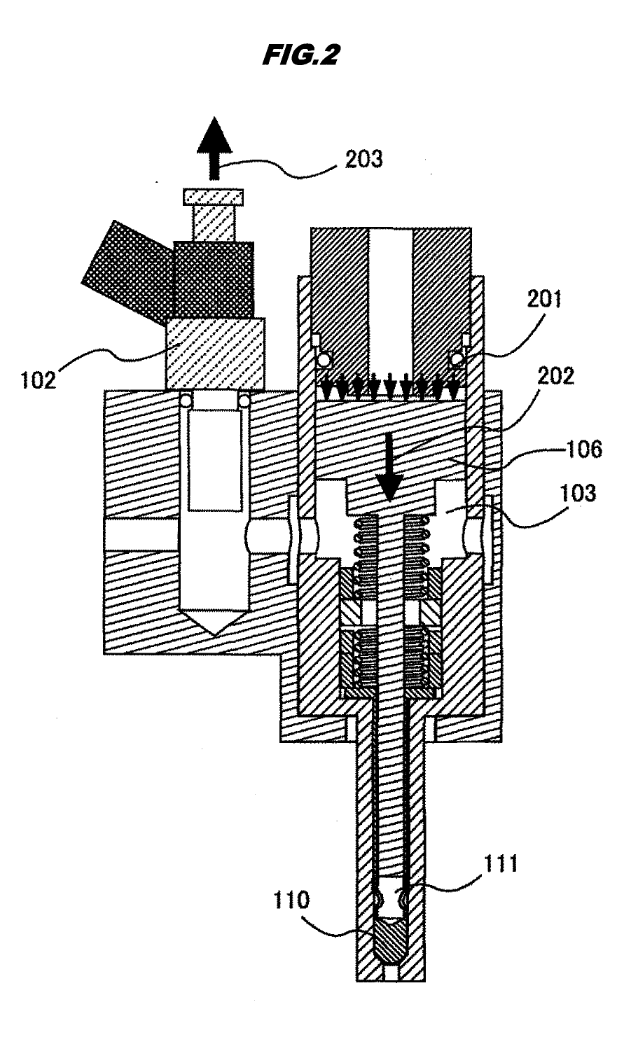

FIG. 2 is a diagram showing the operation of the fuel injector when the control valve 102 is open. When the control valve 102 opens, the fuel flows in the direction shown by an arrow 203 toward the return-side fuel passage communicating with the fuel tank. As a result, the discharge-side fuel passage and the back pressure chamber 103 communicate with each other, and the pressure in the back pressure chamber 103 is almost equalized to the atmospheric pressure. Accordingly, the pressurization piston 106 receives the pressure shown by an arrow 201 due to the supply-side fuel pressure, which moves the pressurization piston 106 downward in the direction shown by an arrow 202.

When the pressurization piston 106 moves downward, the pressure in the pressurization chamber 111 provided in the valve body 110 increases. The pressure during this period is determined by the area ratio of the surface of the pressurization piston 106 which faces the fuel supply side to the surface thereof which faces the pressurization chamber 111.

FIGS. 3A and 3B are enlarged sectional views of the pressurization chamber 111 and its vicinity, showing the operation of the fuel injector when the pressure in the pressurization chamber 111 rises by a downward movement of the pressurization piston 106. The pressurization chamber 111 communicates with a valve-opening pressure chamber 303 through side holes 302 provided in the valve body 110. Thus, the pressure in the pressurization chamber 111 almost equals the pressure in the valve-opening pressure chamber 303.

The valve body 110 is provided with a step at its distal end, and this step serves as a pressure-receiving surface 304. When the pressure in the valve-opening pressure chamber 303 becomes higher than a particular pressure and then the pressure applied to the pressure-receiving surface 304 due to the fuel pressure exceeds the force of the spring 115 for biasing the valve body 110, the valve body 110 moves upward in the direction shown by an arrow 305 resulting in the valve opening operation. When the valve body 110 opens, the pressurized fuel is injected. Here, the predetermined pressure used as the valve-opening pressure can be controlled by the load setting of the spring 115.

In the present embodiment, since the pressurization chamber 111 is disposed in the valve body 110 and in the close vicinity of the valve-opening pressure chamber 303, a fluid passage connecting the pressurization chamber 111 and the valve-opening pressure chamber 303 can be shortened to minimize the amount of fuel compressed during the valve opening operation. For this reason, pressure rise in the pressurization chamber 111 immediately causes pressure rise in the valve-opening pressure chamber 303. Further, the fluid passage connecting the pressurization chamber 111 and the valve-opening pressure chamber 303 can be simply formed by the side holes 302 provided in the valve body 110, making it unnecessary to provide a complicated fluid passage.

The valve body 110 is driven by a differential pressure between the back pressure chamber 103 and the valve-opening pressure chamber 303. Since a clearance is provided between the valve body 110 and the body 108 to allow the valve body 110 to slide with respect thereto, there is fuel leaking from the valve-opening pressure chamber 303 to the back pressure chamber 103. Since the leak flow rate returns excessive compressed fuel to the return passage, the amount of fuel actually injected is reduced resulting in degradation of the efficiency which is represented by the ratio of the volume excluded by the downward movement of the piston to the amount of fuel actually injected.

As a conventional technique, a technique is disclosed for reducing such a leak flow rate by providing a check valve. Specifically, a technique is disclosed for preventing fuel leak by providing a valve which closes with pressure rise in the pressurization chamber. However, there has been a problem that internally providing such a check valve may cause an increase in the structural complexity, size of the fuel injection system, and cost.

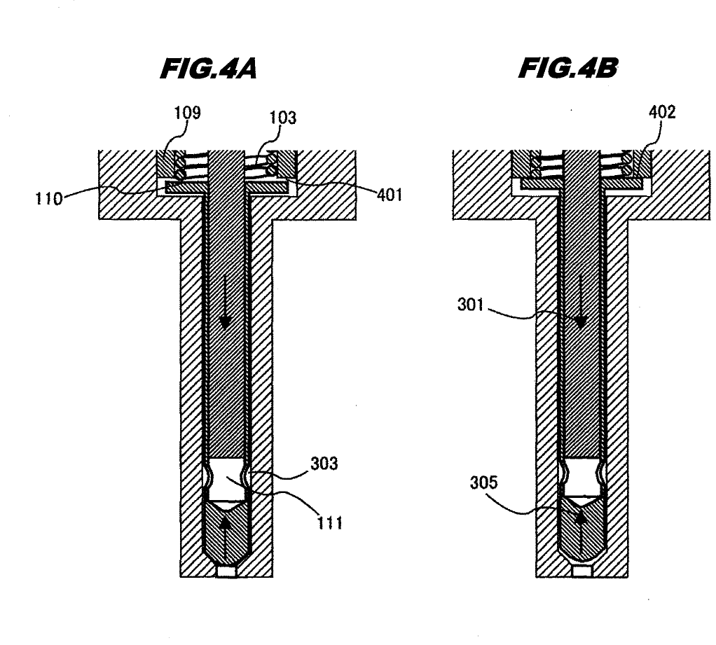

In the present invention, as shown in FIGS. 4A and 4B, when the valve body 110 moves upward to be opened, the valve body 110 collides with the stopper 109 to prevent fuel leak. FIG. 4A is a diagram showing the valve body 110 in the valve closed state. In the valve closed state, a gap 401 is produced between the valve body 110 and the stopper 109, and the fuel can pass therethrough. In the valve open state shown in FIG. 4B, however, the valve body 110 collides with the stopper 109 to form a sealed portion 402, thus preventing the fuel from leaking from the pressurization chamber 111 to the side of the back pressure chamber 103. The sealed portion 402 is formed with the valve body 110 and the stopper 109 in contact with each other so that fuel does not arise at all or the amount of leak is very small.

This effect makes it possible to efficiently inject the pressurized fuel similarly to the case where a check valve is provided. Forming the sealed portion 402 with the stopper 109 and the valve body 110 in contact with each other can obtain the same effect as the case where a check valve is provided while preventing the increase in the structural complexity of the fuel injection system. Specifically, according to the present invention, a fuel injection system of pressure-intensifying type can be configured without providing a check valve.

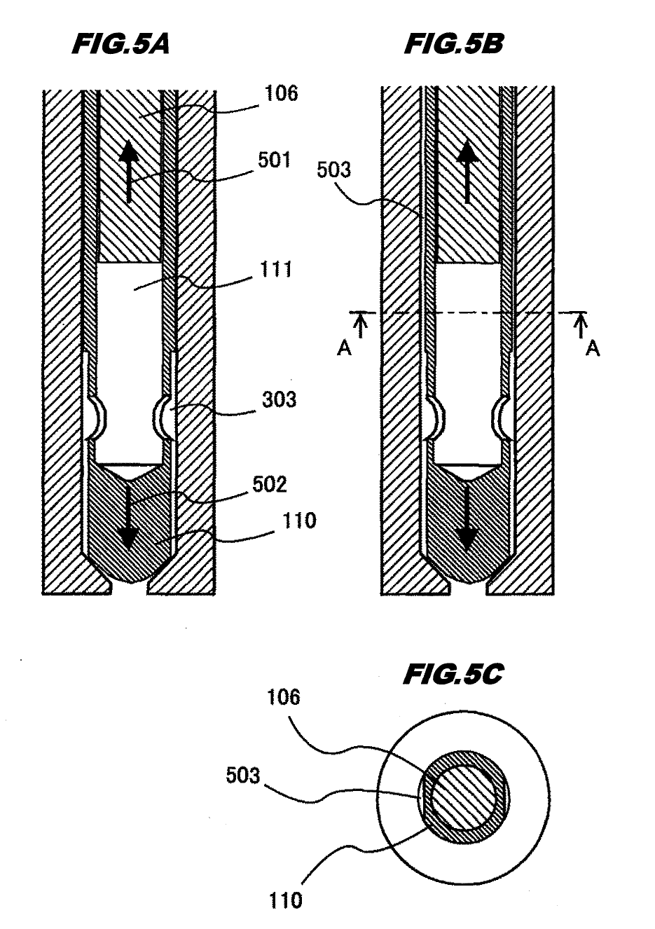

FIGS. 5A and 5B are enlarged sectional front and side views of the vicinity of the end of the valve body of the fuel injection system in the valve closing process. FIG. 5C is a cross sectional view of the vicinity of the end of the valve body of the fuel injection system in the valve closing process. With the fuel injection system according to the present embodiment, when the control valve 102 shown in FIG. 1 is closed, the fuel flows into the back pressure chamber 103 through the clearance between the body 108 and the pressurization piston 106 and accordingly the differential pressure between the back pressure chamber 103 and the space 107 on the fuel supply side disappears. Therefore, the pressurization piston 106 stops moving downward and then starts moving upward by the spring 114.

When the pressurization piston 106 stops moving downward, since the pressurization chamber 111 and the valve-opening pressure chamber 303 are no longer pressurized after fuel injection from the injection nozzle, the pressure in the pressurization chamber 111 and the valve-opening pressure chamber 303 decreases. As the pressure in the valve-opening pressure chamber 303 decreases, the force causing the upward movement of the valve body disappears, and then the valve body 110 moves downward by the load due to the spring 115 and then closes.

When the pressurization piston 106 starts moving upward, the fuel flows into the pressurization chamber 111 with increasing volume of the pressurization chamber 111. As shown in a cross-section along the A-A line of FIG. 5, since a flat portion or the like is formed on the side face of the valve body 106 to provide a fluid passage 503, the fuel passes through the fluid passage 503 and flows into the valve-opening pressure chamber 303 and the pressurization chamber 111. In the fuel inflow process, the valve body 110 is closed and then a gap 402 is produced between the stopper 109 and the valve body 110 shown in FIGS. 4A and 4B, allowing fuel supply.

According to the above-mentioned operating principle, since the amount of downward movement of the pressurization piston can be controlled by the amount of fuel passing through the control valve 102, the amount of fuel injected from the fuel injection system can be controlled. In order to control the amount of fuel passing through the control valve 102, it is preferable to control the valve opening time of the control valve 102, i.e., the time duration in which the control valve 102 is energized. With the use of injection quantity control based on control of the valve opening time of the control valve 102, injection quantity control can be desirably performed by using an on/off valve as the control valve 102. Using the on/off valve as the control valve 102 enables a structurally simpler fuel injector than the use of a proportional valve or the like.

As mentioned above, providing a cavity portion in the valve body 110 and inserting the pressurization piston 106 into the cavity portion form the pressurization chamber 111 in the valve body 110, making it easier to configure a fuel injector which injects fuel with fuel pressure higher than the supply pressure using the fuel as hydraulic oil. Further, forming the sealed portion 402 at a portion where the valve body 110 collides with the stopper 109 makes it possible to inject the fuel that has been efficiently pressurized.

### Second Embodiment

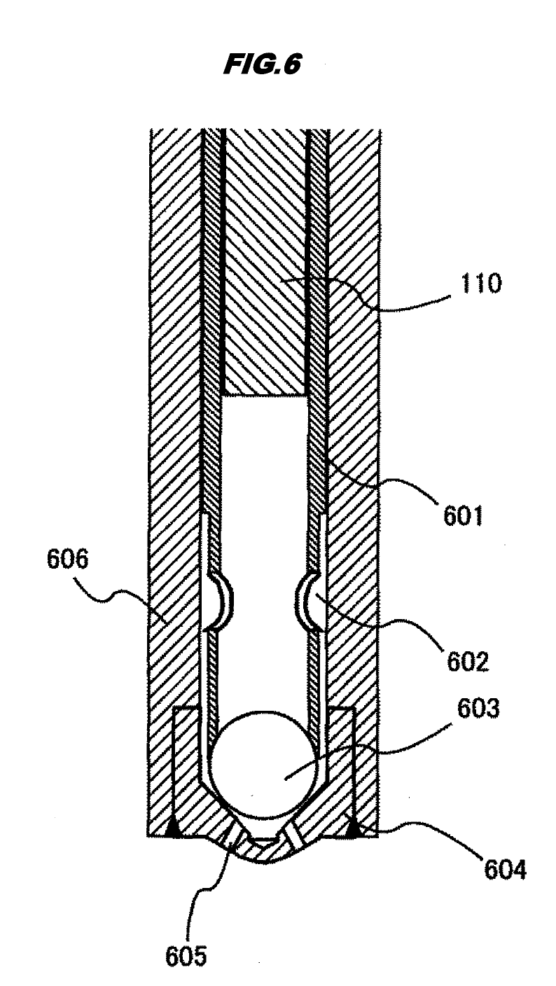

In a second embodiment according to the present invention, as shown in FIG. 6, the valve body of the first embodiment is replaced with a ball 603 and a pipe 601. The pipe 601 and the ball 603 are fixed to each other through welding or the like. The diameter of the pipe 601 is partially differentiated in step manner to form a valve-opening pressure chamber 602. Configuring the valve body with the combination of the pipe 601 and the ball 603 in this way has an advantage that the manufacturing process becomes more simplified than the case shown in the first embodiment.

Since manufacturing a ball having high accuracy is easier than forming a spherical shape at the end of a rod-like object, and a ball is easier to improve the accuracy than a spherical shape, this configuration makes it easier to prevent fuel leak in the valve closed state.

As shown in FIG. 6, the end of the fuel injection system may be formed as a nozzle member 604 which is different from a body 606. Of course, the nozzle of the first embodiment is applicable to the present embodiment, and the nozzle member 604 of the present embodiment is applicable to the first embodiment. Forming the body 606 and the nozzle member 604 as different members in this way makes the manufacturing process easy. Further, forming a nozzle 605 in the nozzle member so as to obtain desired fuel spray makes it possible to design a fuel injector that can obtain fuel spray having a high degree of freedom.

As mentioned above, the second embodiment makes it easier to manufacture the fuel injection system according to the present invention.

### Third Embodiment

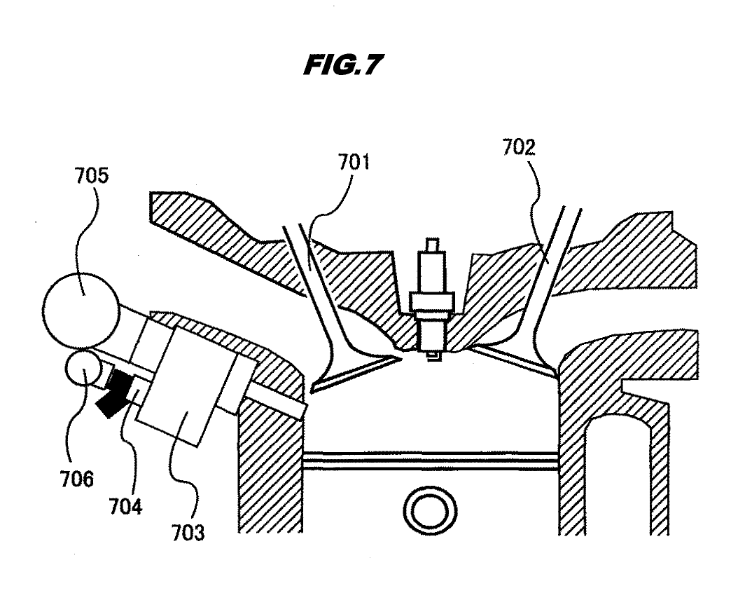

FIG. 7 is a sectional view of a direct-injection internal combustion engine mounting the fuel injection system according to the present invention. A fuel injection system 703 according to the present invention is attached on the side of the suction port valve 701 of the cylinder head of the internal combustion engine so as to inject fuel directly into the cylinder of the internal combustion engine. Fuel is supplied to the fuel injection system 703 through a fuel pipe 705. A return pipe 706 communicating with the fuel tank and a control valve 704 are connected to the fuel injection system 703.

As a conventional technique, a method is known for attaining a direct-injection internal combustion engine by providing a high-pressure fuel pipe, a fuel pump for pressurizing the fuel, and a fuel injector for injecting the high-pressure fuel. With a direct injection engine, abnormal combustion (knocking) can be prevented when injected fuel draws heat in the cylinder. Therefore, an internal combustion engine having a comparatively high compression ratio can be designed; as a result, an internal combustion engine having low fuel efficiency can be manufactured. However, since the use of a high-pressure fuel pump and a high-pressure fuel pipe is necessary, it has been difficult to prevent cost increase.

With the use of the fuel injection system 703 of the present embodiment, a rubber hose or the like can be used as the fuel pipe 705, making it unnecessary to use a high-pressure fuel pump thus attaining a direct-injection internal combustion engine at a low cost.

Generally with a direct-injection internal combustion engine, since the period from injection to ignition is short, it is difficult to completely evaporate the fuel and unburned fuel components tend to be discharged when the internal combustion engine is started up. In particular, since it is necessary to start fuel injection at a timing with insufficient fuel pressure in the high-pressure pipe when the internal combustion engine is started up, the particle diameter of the fuel at engine start-up tends to become large making it difficult to promote evaporation.

When the fuel injection system 703 of the present embodiment is used, a time for raising the pressure in the high-pressure fuel pipe is not required making it possible to inject fuel with sufficiently high pressure from initial injection at engine start-up. As a result, since evaporation of the fuel when the internal combustion engine is started up can be promoted, it becomes possible to provide a direct-injection internal combustion engine which restrains the amount of unburned fuel components.

### Fourth Embodiment

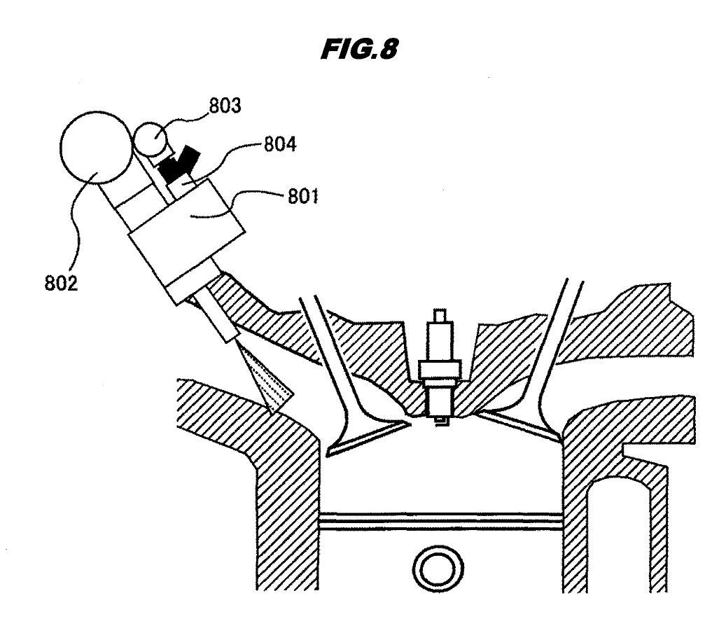

FIG. 8 is a sectional view of an internal combustion engine mounting a fuel injection system according to the present invention in the suction port. A fuel pipe 802 is connected to the fuel supply side of a fuel injection system 801, and a return pipe 803 is connected to a control valve 804.

In this way, attaching the fuel injection system 801 having a pressure intensifier to a suction port 805 makes it possible to supply fuel atomized in the suction port. When the atomized fuel is supplied, since the amount fuel evaporating before the fuel reaches the wall surface of the suction port increases, the amount of fuel adhering to the wall surface of the suction port can be decreased. Therefore, when the fuel evaporates to form a fuel-air mixture, the evaporation latent heat drawn from the wall surface of the suction port decreases, and the fuel evaporates by drawing heat mainly from suctioned air. As a result, the density of the fuel-air mixture suctioned by the internal combustion engine increases to improve the suction efficiency thus improving the power of the internal combustion engine. Further, since air cooled by the fuel is suctioned, the combustion temperature can also be maintained low making it easier to prevent knocking in comparison with the case of a common port-injection internal combustion engine. As a result, it becomes easier to design an engine having a high compression ratio, and therefore an internal combustion engine having low fuel efficiency can be provided.

Mounting the fuel injection system having a pressure intensifier according to the present invention in the suction port is advantageous particularly in increasing the power of an internal combustion engine. With a fuel injection system having a pressure intensifier, a large ratio of the pressure of fuel injection to the pressure of the supplied fuel makes it difficult to increase the fuel injection quantity. However, when the fuel injection system having a pressure intensifier is used for a port-injection internal combustion engine, a sufficient effect can be obtained even if the above pressure ratio is restrained to about 1.5 to 4. This value is used in common internal combustion engines because the particle diameter of the fuel largely depends on the fuel pressure within a fuel pressure range from 0.2 to 0.5 MPa. Particularly with a fuel pressure of 2 MPa or less, the particle diameter largely changes by the fuel pressure and therefore the effect of fuel atomization can be sufficiently obtained even if the pressure increase by the pressure intensifier is restrained to about 1.5 to 4 times. As a result, the fuel injection system according to the present embodiment can be applied to a high power engine requiring a large injection quantity.

### Fifth Embodiment

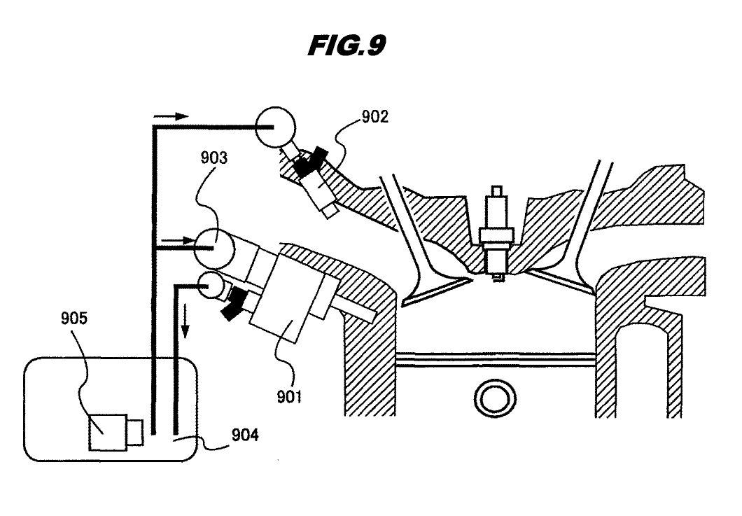

FIG. 9 is a sectional view of an internal combustion engine mounting not only a fuel injection system according to the present invention so as to inject fuel directly into the cylinder but also a common fuel injector in the suction port.

As shown in FIG. 9, a fuel supply side pipe 903 of a fuel injection system 901 and a common fuel injector 902 are connected to a fuel pump 905. The fuel injection system 901 is provided with a pressure intensifier so as to inject the pressurized high-pressure fuel directly into the combustion chamber, and the common fuel injector 902 injects fuel into the suction pipe by the pressure in the fuel supply pipe. It is preferable to set the pressure discharged by the fuel pump 905 to 1 MPa or less so that a low-pressure pipe is used as the fuel pipe. The effect of the present invention can be obtained even if the discharge pressure of the fuel pump 905 is 1 MPa or more. However, when the discharge pressure of the fuel pump 905 is 1 MPa or less, a type of fuel injection system having the fuel pump 905 inside the fuel tank 904 can be used allowing the system to be simplified.

The above-mentioned configuration in which a plurality of fuel injectors are disposed in each cylinder is effective for attaining both high power and low fuel efficiency. The use of the fuel injection system 901 having a pressure intensifier according to the present invention for fuel injection directly into the cylinder makes it possible to inject the high-pressure fuel into the cylinder and accordingly reduce the temperature in the cylinder, thus improving the resistance to knocking. Further, since this configuration has an effect of cooling suction air to improve the suction efficiency, the power can be improved.

When the injection pressure from the fuel injection system 901 to be injected directly into the combustion chamber is intensified to high pressure, it may be difficult to increase the injection quantity from the fuel injection system 901. Therefore, high power can be attained by compensating fuel shortage with the fuel injected from the common fuel injector 902 to the suction pipe.

Further, when a fuel injection system is disposed both in the suction port and in the cylinder in this way, the load of a fuel pump can be reduced in comparison with the case where only the fuel injection system of pressure-intensifying type is disposed in the cylinder. When the fuel injection system of pressure-intensifying type is used, it is necessary to supply a large fuel flow rate from the fuel pump for pressurization. However, the use of the fuel injector 902 disposed in the suction port can minimize the fuel injection quantity by the fuel injector of pressure-intensifying type. As a result, the fuel injector of pressure-intensifying type can be used for a high-power internal combustion engine without remarkably increasing the discharge flow rate of the fuel pump.

As mentioned above, providing a fuel injection system both in the suction port and in the cylinder makes it possible to take full advantage of direct injection without using a high-pressure fuel pipe and, in addition, supply the fuel flow rate required for high power operation using the fuel injector disposed in the suction port.

What is claimed is:

1. A fuel injector comprising:
a fuel injection nozzle through which to inject fuel;
a valve body and a valve seat designed to close a fuel passage therebetween when in contact with each other and to open the fuel passage when separated from each other; and
a pressurization mechanism for pressurizing the fuel so that during fuel injection, the fuel is forced through the fuel passage between the valve body and the valve seat by a higher pressure than a pressure to be supplied to a fuel supply passage,
wherein the pressurization means includes a piston-like member, a first fuel chamber that communicates with the fuel supply passage, and a pressurization chamber for pressuring the fuel therein;
wherein the pressurization chamber is provided inside the valve body such that the pressurization chamber communicates with the fuel injection nozzle via the fuel passage between the valve body and the valve seat; and
wherein the piston-like member is provided in such a way as to be displaceable relative to the valve body and is provided with a first pressure-receiving surface and a pressurization piston portion, the first pressure receiving surface being one end surface of the piston-like member which faces one of the piston displacement directions, that is, faces the first fuel chamber, to receive the fuel pressure acting in the other direction of the piston displacement directions, the pressurization piston portion being provided on the other end surface of the piston-like member which faces the other direction of the piston displacement directions, that is, faces the pressurization chamber, to change the volume of the pressurization chamber, the area of the pressurization piston portion which faces the pressurization chamber being smaller than that of the first pressure-receiving surface.

2. The fuel injector according to claim 1,
wherein the pressurization mechanism is provided with a control valve connected to a pipe having a pressure lower than in the fuel supply passage and with a second fuel chamber communicating with the control valve;
wherein the piston-like member is provided with a second pressure-receiving surface which faces the second fuel chamber to receive the pressure acting in the other direction of the piston displacement directions; and
wherein the piston-like member is driven by a differential pressure between the first and second pressure-receiving surfaces, and the fuel is pressurized by the pressurization piston member changing the volume of the pressurization chamber.

3. The fuel injector according to claim 2,
wherein the piston-like member is driven in the direction to decrease the volume of the pressurization chamber when the control valve makes the second fuel chamber communicate with the pipe having a pressure lower than in the fuel supply passage.

4. The fuel injector according to claim 1,
wherein the fuel injector includes a fuel passage for introducing the fuel into the pressurization chamber at the outer section of the valve body and a stopper member for limiting the lift amount of the valve body so as to prevent the flow of the fuel in the fuel passage between the stopper member and the valve body when the valve body is lifted from the valve seat.

5. The fuel injector according to claim 2,
wherein the injection quantity of the fuel is controlled by the amount of time during which the control valve is open.

6. An internal combustion engine including the fuel injector defined in claim 1, the fuel injector being disposed such that the fuel injection nozzle faces the inside of a cylinder of the internal combustion engine,
wherein the pressure with which the fuel is supplied to the fuel injector is set to 1 MPa or less.

7. The internal combustion engine according to claim 6,
wherein another fuel injector is provided in the suction port of the internal combustion engine.
